(19) United States
(12) Patent Application Publication
(10) Pub. No.: US 2012/0252279 A1
(43) Pub. Date: Oct. 4, 2012

(54) Connector And Power Management System For The Same

(76) Inventors: Gang Lee, Shanghai (CN); Huibin Li, Shanghai (CN); Wei Yao, Shanghai (CN)

(21) Appl. No.: 13/433,966

(22) Filed: Mar. 29, 2012

(30) Foreign Application Priority Data
Mar. 29, 2011 (CN) 201110083938.0

(51) Int. Cl. H01R 24/28

(52) U.S. Cl. 439/660

(57) ABSTRACT

A connector is provide that disconnects from a power source when not in operation. The connector includes an insulation body holding a first contact and a second contact positioned adjacent thereto. The second contact is movable between a first position in contact with the first contact, and a second position spaced from the first contact to accommodate a mating connector.

### CROSS-REFERENCE TO RELATED APPLICATION

This application claims priority under 35 U.S.C. §119 to Chinese Patent Application No. 201110083938.0, filed on Mar. 29, 2011.

### FIELD OF THE INVENTION

The invention relates to a connector and, more particularly, relates to a USB (Universal Serial Bus) connector and a power management system for the USB connector that can save power.

### BACKGROUND

Once a known USB connector (such as a USB 2.0 or USB 3.0) is electrically connected to a printed circuit board (PCB) of a host computer, a power supply of the host computer maintains an electrical communication with the known USB connector and keeps on an electric power to the known USB connector, whether the known USB connector is electrically connected to a mating USB connector or not.

More often that not, the known USB connector is not connected to the mating USB connector. However, in the known USB connector, electrical connection with the power supply of the host computer is maintained. Correspondingly, the known USB connector itself consumes some power energy even if it is not connected to the mating USB connector, and therefore it does not agree with design requirements to save energy.

### SUMMARY

The invention has been made to overcome the above mentioned disadvantages, among others. Correspondingly, it would be advantageous to provide a USB connector and a power management system that can detect operation of the connector and switch off or switch on the connector corresponding to the detected operation of the connector so as to save the power energy; that is, the power management system switches off the USB connector when a mating USB connector is not electrically connected to it is detected, and switches on the connector when the mating USB connector is electrically connected to it is detected.

The connector, according to the invention, includes an insulation body holding a first contact and a second contact positioned adjacent thereto. The second contact is movable between a first position in contact with the first contact, and a second position spaced from the first contact to accommodate a mating connector.

### BRIEF DESCRIPTION OF THE DRAWINGS

The above and other features of the present invention will become more apparent by describing in detail exemplary embodiments thereof with reference to the accompanying drawings, in which:

FIG. 1 is an exploded perspective view of a connector corresponding to the invention;

FIG. 2 is a perspective view showing contacts assembled in an insulation body of connector shown in FIG. 1;

FIG. 3 is a perspective view of an assembled connector corresponding to the invention;

FIG. 4 is a schematic view of a PCB for the connector shown in FIG. 3;

FIG. 5 is a bottom perspective view of the connector corresponding to the invention mounted on the PCB shown in FIG. 4;

FIG. 6 is perspective view of a detection contact and a ground contact of the connector corresponding to the invention that in electrical contact with each other;

FIG. 7 is a side view of the detection contact and the ground contact of the connector corresponding to the invention that are separated from each other when the connector is connected with a mating connector;

FIG. 8 is a perspective view of the connector corresponding to the invention mounted on another PCB;

FIG. 9 is perspective view of a detection contact and a ground contact of the connector shown in FIG. 8 that in electrical contact with each other; and

FIG. 10 is a side view of the detection contact and the ground contact of the connector shown in FIG. 8 that are separated from each other when the connector is connected with a mating connector.

### DETAILED DESCRIPTION OF THE EMBODIMENT(S)

Exemplary embodiments of the invention will be described hereinafter in detail with reference to the attached drawings, wherein the like reference numerals refer to the like elements. The invention may, however, be embodied in many different forms and should not be construed as being limited to the embodiment set forth herein; rather, these embodiments are provided so that the description of the present invention will be thorough and complete, and will fully convey the concept of the invention to those skilled in the art.

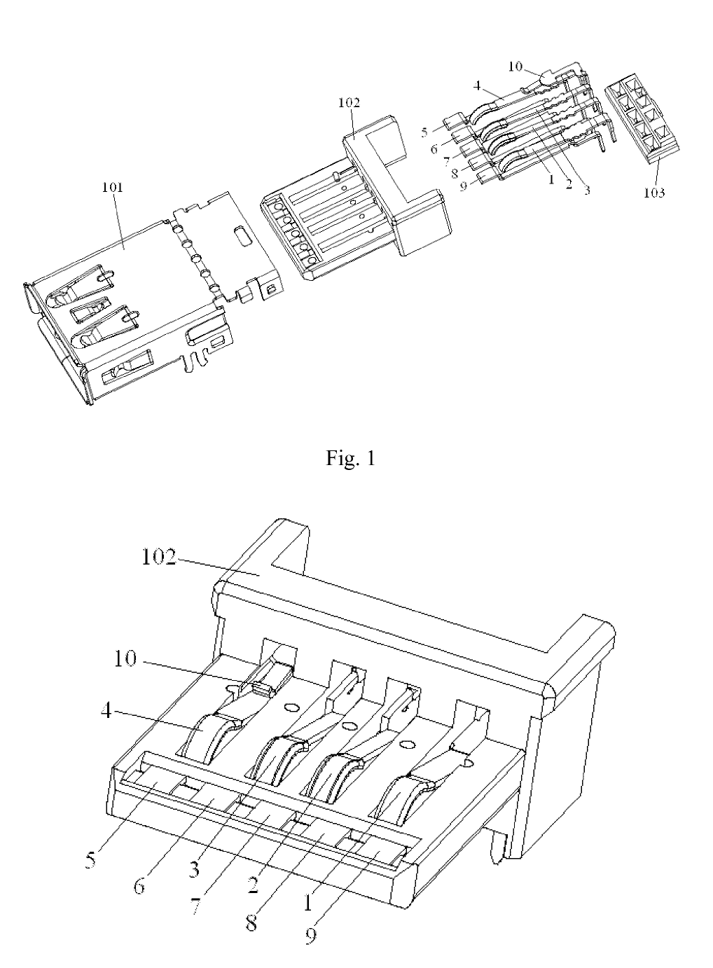

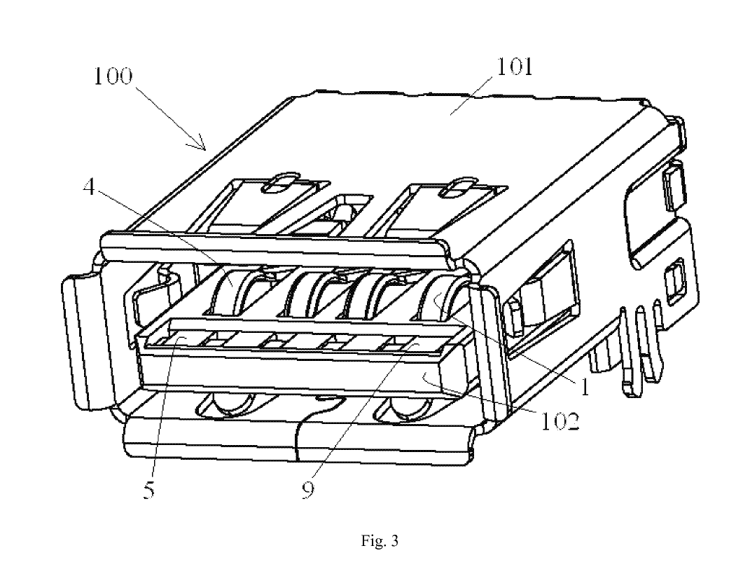

With reference to FIGS. 1 through 3, a connector 100 is shown, which includes a metal shield 101, an insulation body 102, a plurality of contacts 1, 2, 3, 4, 5, 6, 7, 8, 9, 10, and a rear insulation holder 103.

In the shown embodiment of FIGS. 1 through 3, the connector 100 agrees with a traditional USB 3.0 design standard, except that an additional detection contact 10 is provided. Because the traditional USB 3.0 design standard is well-known to those skilled in this art, for the sake of brevity, its detailed description is omitted herein.

Note that the invention is not limited to the USB 3.0 design standard. Rather, the connector 100 may correspond to other design standards, for example, a USB 2.0 connector, and the like, except that the additional contact 10 is provided. Furthermore, the connector 100 may be a male or female/receptacle type connector.

As shown in FIG. 1, the connector 100 includes a pair of contacts 2, 3 that are a pair of low-speed differential signal contacts, which may be compatible with a USB 2.0 connector. The connector further includes a pair of contacts 5, 6 and a pair of contacts 8, 9, which are two pairs of high-speed differential signal contacts. The connector also includes a common power contact 1, a ground contact 4 for the USB 2.0 connector, a ground contact 7 for the USB 3.0 connector, and the detection contact 10.

As shown in FIG. 1 the detection contact 10 is disposed adjacent to the ground contact 4, and the detection contact 10 and the ground contact 4 are arranged to together to form a pair of contacts that detect an operation of the connector 100.

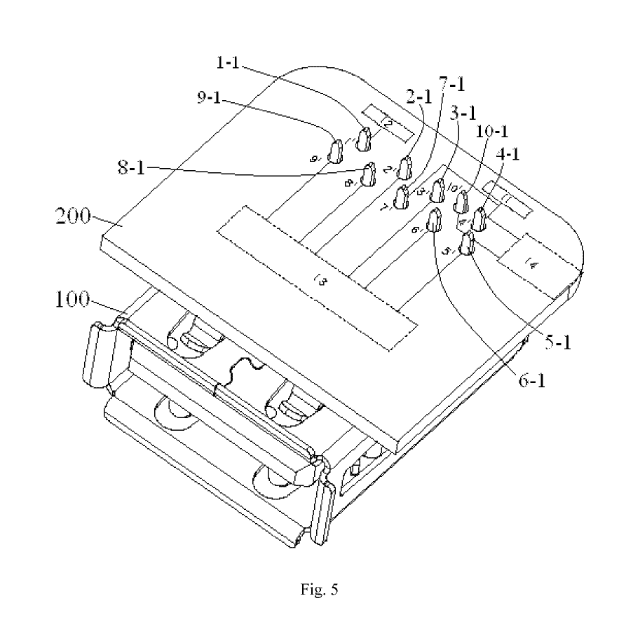

Referring to FIGS. 1 through 3, the contacts 1, 2, 3, 4, 5, 6, 7, 8, 9, 10 of the connector 100 are assembled in an insulation body 102. These contacts 1, 2, 3, 4, 5, 6, 7, 8, 9, 10 of the connector 100 have pins 1-1, 2-1, 3-1, 4-1, 5-1, 6-1, 7-1, 8-1, 9-1, and 10-1 (see FIG. 5) which are positioned at a rear end of the contacts 1, 2, 3, 4, 5, 6, 7, 8, 9, 10, respectively. All of the pins 1-1, 2-1, 3-1, 4-1, 5-1, 6-1, 7-1, 8-1, 9-1, and 10-1 are secured and positioned in slots of the insulation holder 103. The insulation body 102 and the insulation holder 103 are enclosed in the metal shield 101.

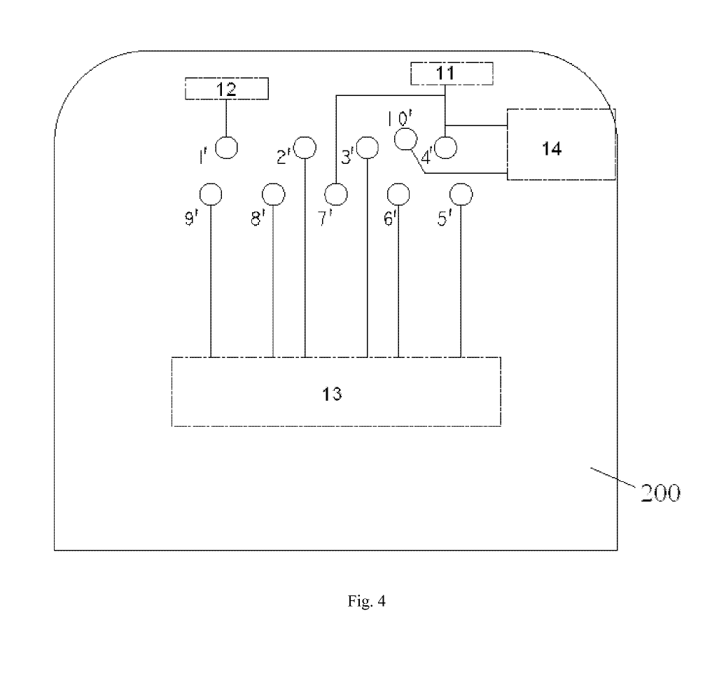

A PCB 200 for the connector 100 will be described with reference to FIGS. 4 and 5. As shown in FIG. 4, the PCB 200 includes pin receiving passageways 1′, 2′, 3′, 4′, 5′, 6′, 7′, 8′, 9′, and 10′ which receive with the pins 1-1, 2-1, 3-1, 4-1, 5-1, 6-1, 7-1, 8-1, 9-1, and 10-1 of the connector 100, respectively.

Although the connector 100 is mounted on the PCB 200 with 1-1, 2-1, 3-1, 4-1, 5-1, 6-1, 7-1, 8-1, 9-1, and 10-1 extending through the pin receiving passageways 1′, 2′, 3′, 4′, 5′, 6′, 7′, 8′, 9′, and 10′, as shown in FIGS. 4 and 5, the invention is not limited to the shown embodiment, and the connector 100 may be mounted on the PCB 200 using other known technologies, such as Surface Mount Technology (SMT).

With reference to FIGS. 4 and 5, a signal control module 13 is integrated into the PCB 200. The pins 2-1, 3-1, 5-1, 6-1, 8-1, 9-1 of the signal contacts 2, 3, 5, 6, 8, 9 are electrically connected to the signal control module 13 through respective wirings on the PCB 200.

As shown in FIGS. 4 and 5, a ground module 11 is further integrated into the PCB 200. The pins 4-1, 7-1 of the ground contacts 4, 7 of the connector 100 are electrically connected to the ground module 11 through respective wirings on the PCB 200.

A bus-power supplying module 12 is further integrated into the PCB 200. The pin 1-1 of the power contact 1 of the connector 100 is electrically connected to the bus-power supplying module 12 through wiring on the PCB 200.

A power control module 14 is further integrated into the PCB 200. The power control module 14 is electrically connected to the pin 10-1 of the detection contact 10 and the pin 4-1 of ground contact 4 through respective wirings on the PCB 200. The operation of the power control module 14 will be described in detail as follows.

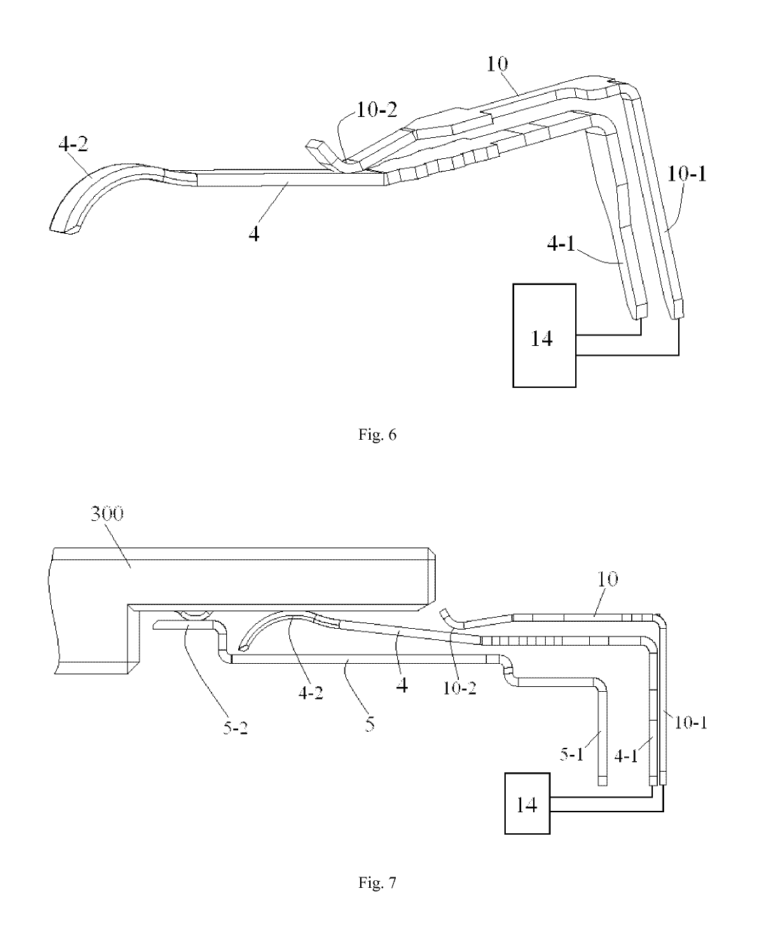

FIGS. 6 and 7 illustrate an operation of a power management system for the connector 100 corresponding to the invention. In brief, the detection contact 10 and ground contact 4 of the connector 100 in electrical contact with each other when a mating connector 300 is not inserted into the connector 100 (see FIG. 6), but are separated from each other when the mating connector 300 is inserted into the connector 100 (see FIG. 7).

As shown in FIG. 6, before a mating connector 300 (see FIG. 7, for example, a plug of a flash memory or a portable hard disk) is inserted into the connector 100, the ground contact 4 is kept in electrical contact with the detection contact 10. At this time, the power control module 14 is electrically connected to the ground contact 4 and the detection contact 10 may detect an electrical connection between the ground contact 4 and the detection contact 10 and may determine that the connector 100 is not connected to a mating connector 300 based on the detected connection result. Correspondingly, once the power control module 14 detects that the connector 100 is connected to the mating connector 300, the power control module 14 sends a signal to a power supply of a host computer to switch off the electric power supplied to the connector 100. In this way, all electronic elements of the connector 100 are switched off when the connector 100 is not connected to the mating connector 300, for instance.

As shown in FIG. 7, after the mating connector 300 is inserted into the connector 100, the mating connector 300 forces the ground contact 4 to electrically separate it from the detection contact 10. At this time, the power control module 14 electrically connected to the ground contact 4 and the detection contact 10 may detect an electrical disconnection between the ground contact 4 and the detection contact 10 and may determine that the connector 100 is connected to the mating connector 300 based on the detected disconnection result. Correspondingly, once the power control module 14 detects that the connector 100 is connected to the mating connector 300, the power control module 14 sends a signal to the power supply of the host computer to switch on the electric power supplied to the connector 100.

Referring back to FIG. 6, before the mating connector 300 is inserted into the connector 100, as shown, an end 10-2 of the detection contact 10 is elastically bias toward and touches the ground contact 4. Therefore, the detection contact 10 is electrically connected with the ground contact 4.

Now with reference to FIG. 7, after the mating connector 300 is inserted into the connector 100, the detection contact 10 separates from the ground contact 4 and is not connected to the mating connector 300, and the other contacts of the connector 100 are still kept in contact with the mating connector 300, for example, as shown in FIG. 7, ends 4-2, 5-2 of the contacts 4, 5 are elastically deformed and electrically connected with the mating connector 300.

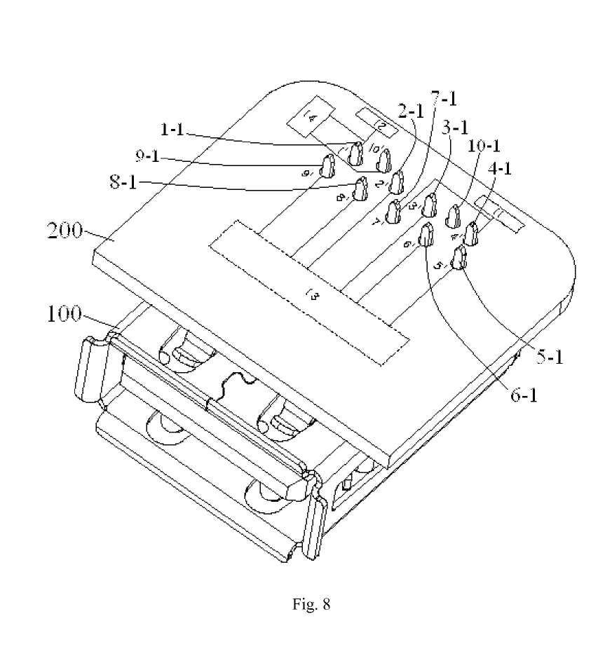

FIG. 8 shows a connector 100 mounted on a PCB 200 corresponding to another embodiment of the invention. However, the difference between the embodiment shown in FIGS. 8-10 and the embodiment shown in FIGS. 1-7 is in that the detection contact 10 and the power contact 1 are arranged together and form a pair of contacts for detecting operation of the connector 100 when connected with the mating connector 300. However, it should be noted that the invention is not limited to this, and the pair of contacts may consist of the detection contact 10 and any one of other contacts of the connector 100. For example, the detection contact 10 and one low-speed differential signal contact 2 may be arranged together to form a pair of contacts to detect an operation of the connector 100, or the detection contact 10 and one high-speed differential signal contact 8 may be arranged together to form a pair of contacts to detect the operation of the connector 100.

As shown in FIG. 8, a power control module 14 is integrated into the PCB 200. The power control module 14 is electrically connected to a pin 10-1 of the detection contact 10 and a pin 1-1 of the power contact 1 through respective wirings on the PCB 200. The operation of the power control module 14 will be described in detail as follows.

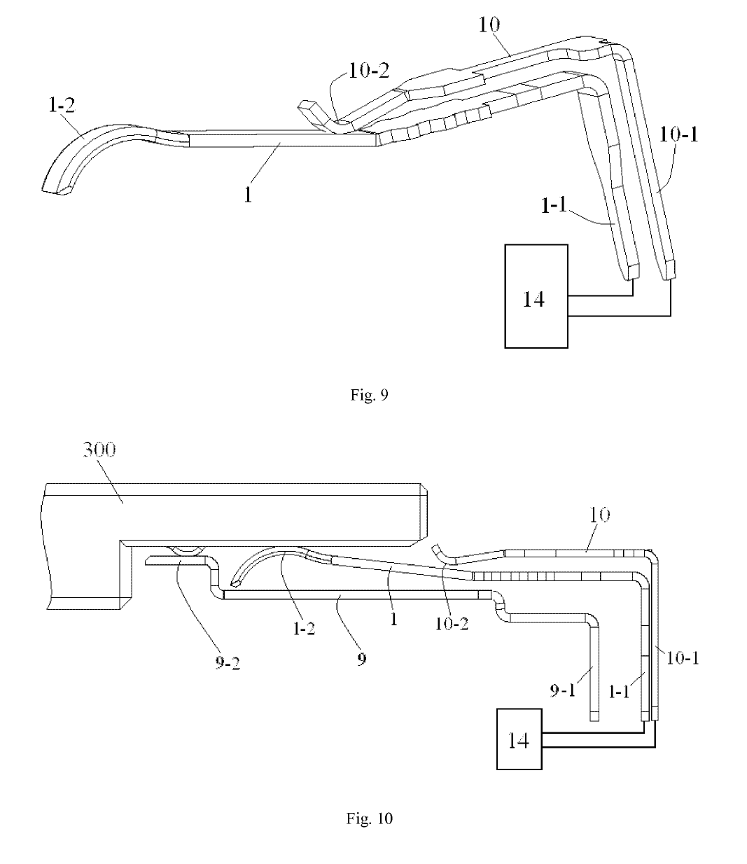

As shown in FIG. 9, before a mating connector 300 (see FIG. 10, for example, a plug of a flash memory or a portable hard disk) is inserted into the connector 100, the power contact 1 maintains electrical connection with the detection contact 10. At this time, the power control module 14 is electrically connected to the power contact 1 and the detection contact 10 may detect an electrical connection between the power contact 4 and the detection contact 10, and also determine that the connector 100 is not connected to the mating connector 300 based on the detected connection result. Correspondingly, once the power control module 14 detects that the connector 100 is not connected to the mating connector 300, the power control module 14 sends a signal to a host computer to switch off the electric power supplied to the connector 100. Correspondingly, all electronic elements of the connector 100 are switched off when the connector 100 is not connected to the mating connector 300.

As shown in FIG. 10, after the mating connector 300 is inserted into the connector 100, the mating connector 300 forces the power contact 1 to separate from the detection contact 10. At this time, the power control module 14 is electrically connected to the power contact 1 and the detection contact 10 may detect an electrical disconnection between the power contact 1 and the detection contact 10, and then determine that the connector 100 is connected to the mating connector 300 based on the detected disconnection result. Correspondingly, once the power control module 14 detects that the connector 100 is connected to the mating connector 300, the power control module 14 sends a signal to the power supply of the host computer to switch on the electric power supplied to the connector 100.

Referring to FIG. 9, before the mating connector 300 is inserted into the connector 100, an end 10-2 of the detection contact 10 is elastically bias toward and touches the power contact 1. Therefore, the detection contact 10 is electrically connected with the power contact 1.

Now with reference to FIG. 10, after the mating connector 300 is inserted into the connector 100, the detection contact 10 is separated from the power contact 10 and is not connected to the mating connector 300. The other contacts of the connector 100 are still kept in contact with the mating connector 300, for example, as shown in FIG. 10, the ends 1-2, 9-2 of the contacts 1, 9 of the connector 100 are kept electrically connected with the mating connector 300.

Since the detection contact 10 is disposed in the connector 100 for detecting the operation of the connector 100, the power supplied to the connector 100 can be managed. Correspondingly, the connector 100 may be switched off when a mating connector 300 is not connected, but switched on once the mating USB connector 300 is connected. In this way, it may save the power energy.

Although several exemplary embodiments have been shown and described, it would be appreciated by those skilled in the art that various changes or modifications may be made in these embodiments without departing from the principles and spirit of the invention, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector comprising:
an insulation body;
a first contact mounted in the insulation body;
a second contact mounted in the insulation body: and
(1) adjacent to the first contact, and
(2) movable between:
(a) a first position in contact with the first contact, and
(b) a second position spaced from the first contact to accommodate a mating connector.

2. The connector corresponding to claim 1, further comprising a printed circuit board positioned below the insulation body.

3. The connector corresponding to claim 1, wherein second contact is soldered on the printed circuit board using surface mount technology.

4. The connector corresponding to claim 1, wherein the second contact is flexible and elastically biased toward the first contact to touch the first contact when in the first position.

5. The connector corresponding to claim 4, wherein the second contact is electrically connected to the first contact when in the first position.

6. The connector corresponding to claim 5, wherein the second contact is elastically deformed and separated from the first contact by the connecting mating connector.

7. The connector corresponding to claim 6, wherein the connector includes a power contact, a ground contact, and a signal contact and the second contact is one of the power contact, the ground contact, and the signal contact.

8. A power management system comprising:
a connector having:
an insulation body,
(1) a first contact mounted in the insulation body, and
(2) a second contact mounted in the insulation:
(a) adjacent to the first contact, and
(b) movable between:
(i) a first position in contact with the first contact, and
(ii) a second position spaced from the first contact to accommodate a mating connector.
a power control module electrically connected to the second contact and the first contact for preventing electric power transmission between the connector and the mating connecter when the second contact is in the second position separated from the first contact.

9. The power management system corresponding to claim 8, wherein the connector includes a power contact, a ground contact, and a signal contact and the second contact is one of the power contact, the ground contact, and the signal contact.

10. The power management system corresponding to claim 8, further comprising a printed circuit board to which the first contact and the second contact are electrically connected.

11. The power management system corresponding to claim 10, wherein the power control module is integrated into the printed circuit board.

12. The power management system corresponding to claim 11, further comprising a signal control module integrated with the printed circuit board.

13. The power management system corresponding to claim 12, wherein the connector includes a power contact, a ground contact, and a signal contact and the second contact is the signal contact electrically connected to the signal control module.

14. The power management system corresponding to claim 11, further comprising a ground module is integrated into the printed circuit board.

15. The power management system corresponding to claim 14, wherein the connector includes a power contact, a ground contact, and a signal contact and the second contact is the ground contact electrically connected to the ground module.

16. The power management system corresponding to claim 11, further comprising a bus-power supplying module is integrated into the printed circuit board.

17. The power management system corresponding to claim 16, wherein the connector includes a power contact, a ground contact, and a signal contact and the second contact is the power contact electrically connected to the bus-power supplying module.

18. The power management system corresponding to claim 11, wherein the connector is mounted on the printed circuit board in a pin-insertion manner.

19. The power management system corresponding to claim 18, wherein each of the first contact and the second contact includes a pin at one end thereof.

20. The power management system corresponding to claim 19, wherein the printed circuit board includes pin receiving passageways receiving the pin of the first contact and the pin of the second contact.
